(19) United States
(12) Patent Application Publication
(10) Pub. No.: US 2026/0147657 A1
(43) Pub. Date: May 28, 2026

(54) ERROR LOG ACCESS TECHNOLOGIES

(71) Applicant: Intel Corporation, Santa Clara, CA (US)

(72) Inventors: John G. HOLM, Beaverton, OR (US); Shubhada PUGAONKAR, Portland, OR (US); Theodros YIGZAW, Sherwood, OR (US); Taniya SIDDIQUA, Bothell, WA (US); Keshavan TIRUVALLUR, Tigard, OR (US); Samuel A. MATTORD, Austin, TX (US); Sarathy JAYAKUMAR, Portland, OR (US); Mariusz ORIOL, Gdynia (PL)

(21) Appl. No.: 19/379,289

(22) Filed: Nov. 4, 2025

(51) Int. Cl. G06F 11/07; G06F 11/14; G06F 11/34

(52) U.S. Cl. CPC G06F 11/0772; G06F 11/1441; G06F 11/3476

(57) ABSTRACT

Examples described herein relate to an interface and a core coupled to the interface, wherein based on a configuration, the core is to respond to an interrupt indicating an error by outputting error data to a management controller while permitting thread execution on the core. In some examples, based on the configuration, the core is to invoke the management controller to handle errors and not enter System Management Mode (SMM).

Machine error logs are records of errors that occur in a computer's software or hardware. Machine error logs contain details such as timestamps, the source of the error, severity level, and a descriptive message. Machine error logs are used for troubleshooting and maintenance of a computer's software or hardware and help to diagnose issues ranging from application crashes to system failures and security breaches. Machine Check Architecture (MCA) banks are architecturally defined error log registers that are accessible to a processor-executed Operating System (OS).

### BRIEF DESCRIPTION OF THE DRAWINGS

FIG. 1 depicts an example system.

FIG. 2 depicts an example operation of a system.

FIG. 3 depicts an example operation.

FIG. 4 depicts an example operation.

FIG. 5 depicts an example process.

FIG. 6 depicts an example computing system.

### DETAILED DESCRIPTION

For runtime error handling, receipt of a System Management Interrupt (SMI) can invoke System Management Mode (SMM). When the system enters SMM, the firmware can perform low-level management operations such as changing fan speeds, checking thermal zones, adjusting the processor frequency, etc. Intel® and Advanced Micro Devices (AMD)® processors utilize SMM to provide customers an infrastructure to manage warranties, apply Reliability, Availability, and Serviceability (RAS) actions and provide out-of-band (OOB) error visibility by making a copy of the error logs. However, SMM can cause processor performance degradation by stalling core-executed threads, which may violate Cloud Service Provider (CSP) uptime percentage and Service Level Agreements. Additionally, SMM is a target for attackers because SMM provides full access to physical memory (including virtual machine manager (VMM) or operating system (OS) memory space) and hardware resources (e.g., input/output (I/O) ports, registers, etc.). In Advanced RISC Machines (ARM) architecture the Exception Level 3 (EL3) mode is also referred as SMM. Not that reference to SMM can refer EL3 or SMM.

A Corrected Machine Check Interrupt (CMCI) delivered as an SMI (CSMI) interrupt signaling can indicate corrected errors (CE) or UnCorrected No Action required (UCNA) errors. Various examples can utilize CSMI signaling to invoke microcode (uCode) but not enter the SMM mode. Instead, uCode can convert the CSMI into a no-operation (nop) within the core and issue a signal to cause a management controller to read the error data from registers. To read the registers, management controller can send register read commands to the core for execution so that the core can read error data from the error registers. The management controller perform operations of an error handler by collecting error data and providing error data to a user and clearing error state so that additional errors can be logged. If there are any unexpected SMI errors logged as an MCA error, the platform can reset or shutdown.

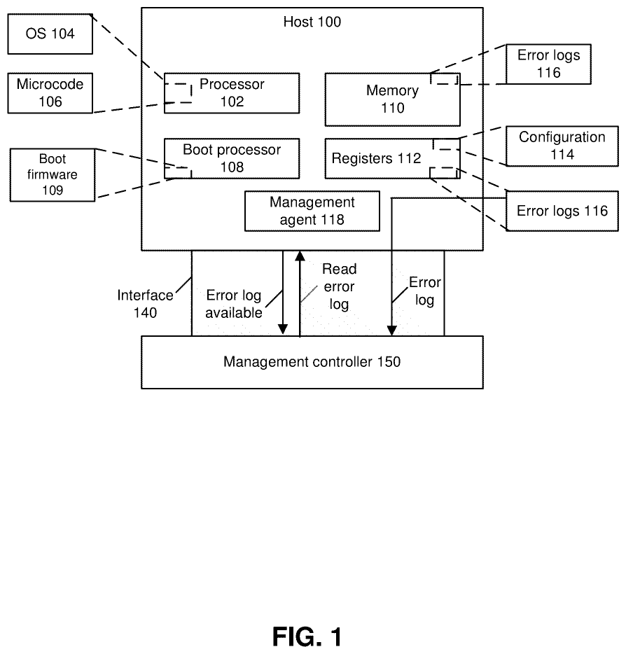

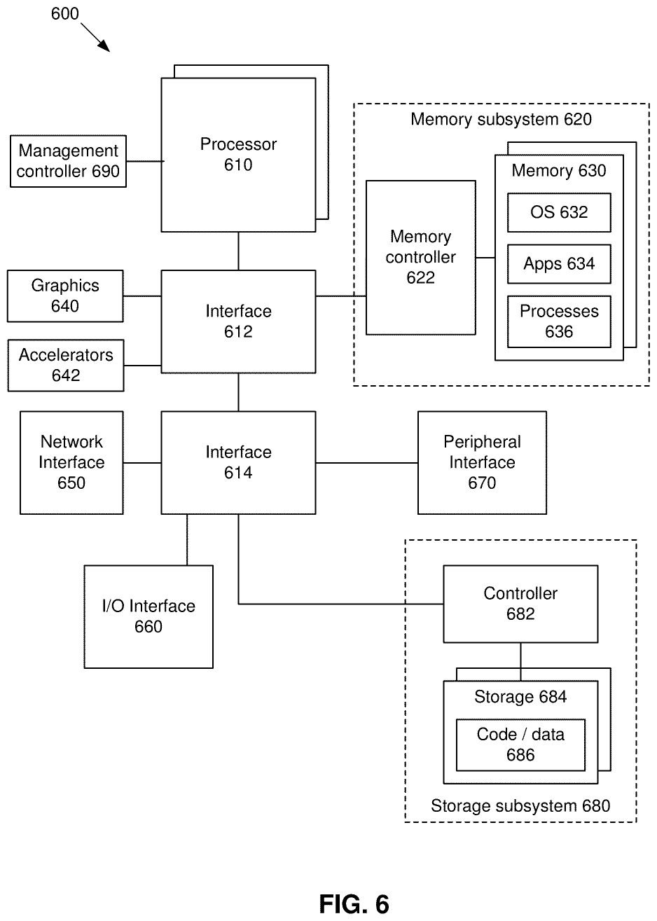

FIG. 1 depicts an example system. Various examples of circuitry and software that can be utilized by host 100 are described at least with respect to FIG. 6. Processor 102 can execute at least operating system (OS) 104 and microcode (Ucode) 106. As described herein, Ucode 106 can be configured to not enter SMM based on receipt of a CSMI and permit management controller 150 to access error logs 116 via registers or via memory 110 allocated to an or out of band (OOB) management agent 118.

Boot processor 108 can execute boot firmware 109. Boot firmware 109 can enable or not enable NoSMM mode 114 in registers 112 during boot of host 100. In some examples, firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include Server Platform Services (SPS).

In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware. A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

Registers 112 can include at least platform state register, uncore register, or others memory or cache. Registers 112 can store instructions, store operands for arithmetic and logic operations, memory addresses for instructions or data, a result of processor operations, or other data. Registers 112 can include MCA banks that store specific error codes and status information for a hardware error (e.g., memory, cache, or bus error).

In a first configuration of configuration 114, receipt of CSMI signaling causes entry into SMM mode. In a second configuration of configuration 114 (NoSMM mode), CSMI signaling does not cause entry into SMM mode and microcode (uCode) 106 converts the CSMI to a no-operation (nop) and issues a signal on a pin (Err0) to management controller 150, which causes management controller 150 to access error logs 116. In a third configuration of configuration 114, receipt of CSMI signaling causes copying error data to error buffer of an management system (e.g., management agent 118) for access by management controller 150 and OS 104 can access the errors.

Configuration 114 can specify: based on receipt of an SMI or CSMI, processor-executed ucode 106 can perform at least: (1) enter SMM or do not enter SMM; (2) send error0 signal to management controller 150 to read registers to access error logs or signal Machine Check Exception (MCE); or (3) push error data to error buffer of an management system for access by management controller 150.

An unexpected SMI error logged as Machine Check Architecture (MCA) error can cause the platform to reset or shutdown. Unexpected SMIs can include OS 104 invoked SMI by writing to a particular IO port (e.g., 0xB2) when NoSMM mode is in effect. Unexpected SMIs can include hardware invoking SMI apart from the MCA as such hardware should have been configured to be turned off.

An example of configuration 114 is as follows. However, variations of the register entries can be utilized such as different bit range sizes, different field names, different operations, different bit values for enabling or disabling a feature, or others.

| Bit | |
|---|---|
| Range | Field Name (ID): Example Description |
| 0 | ErrOnSMM: |
| | When set, this bit does not allow threads to enter SMM. |
| | If CSMI_SOURCE_LOG_EN bit is set, CSMI will not cause |
| | MCE. |
| | But if CSMI_SOURCE_LOG_EN bit is not set, a machine |
| | check exception (MCE) can be pended based on receipt |
| | of an SMI by the core. In some examples, ErrOnSMM can |
| | be set after SMI sources do not trigger entrance into |
| | SMM and alternate mechanisms of error handling (outside |
| | of SMM) can be configured. |
| 1 | CSMI_SOURCE_LOG_EN: |
| | If this bit is not set, CSMI errors may not be accessed by |
| | the OS and management controller 150 can read the CSMI |
| | errors from the registers. Such errors can be cloaked to the |
| | OS. Operations triggered by this bit being enabled can prevent |
| | a CSMI from causing entrance into SMM and can cause the |
| | CSMI to result in the setting of the ERR0 pin to trigger |
| | management controller to issue read and write commands to a |
| | core. This bit can be set independently from the ErrOnSMM. |
| | If this bit is not set, ErrOnSMM = ‘1’ causes machine check |
| | exceptions (MCE) based on receipt of SMIs, including CSMI. |
| 2 | SRAR_COPY_LOG_EN: |
| | This bit enables logging of software recoverable action |
| | required errors (SRAR) errors into the RAS error tracer |
| | buffer in agent 118. OS handler can handle the errors (e.g., |
| | clear the errors to allow other errors to be logged and |
| | terminate the process which caused the error). Management |
| | controller 150 can read errors from agent 118 before OS |
| | performs actions that clear the errors and terminate the process. |
| | The operations triggered by this bit being enabled has no |
| | dependency on SMM or SMI and can be used independently of |
| | the ErrOnSMM bit (bit 0). |
| 3:63 | Reserved |

Management controller 150 can read error log data 116 associated with error by sending register read commands (e.g., RDIAMSR) to processor 102 and causing processor 102 to execute register read commands to read error data 116 and provide error data 116 to management controller 150. Management controller 150 or an OOB agent can cause processor 102 to execute register write commands (e.g., WRIAMSRx) to cause processor 102 to execute register write commands to clear error log data 116 in register 112 so that additional errors can be logged to register 112.

Management controller 150 can perform error handling by collecting error data 116 from registers 112 (e.g., Model-Specific Registers (MSRs)) and provide error data 116 to a data center administrator, orchestrator, operating system (OS), management controller or others. A Reliability, Availability, and Serviceability (RAS) manager service, running on management controller 150, can output the data on an interface. In some cases, hardware (e.g., Error-Correcting Code (ECC) protection within a cache) can address errors by performing error correction and error data 116 can indicate occurrences of corrected errors. In some cases, OS 104 can perform error correction such as cause address row or bank associated with memory errors to not be utilized; Soft Post Package Repair (sPPR) to perform an in-system memory repair process that fixes a faulty memory row by redirecting requests to a spare row for the current session; based on error indication from a core or device, shifting use to a different core or device; or others.

Management controller 150 can include a processor configured to perform monitoring of server health, including temperature, fan speeds, and power status. Management controller 150 can be configured to respond to remote actions by performance of actions such as power cycling, booting, and resetting the server. Management controller 150 can provide management capabilities independent of the OS, through a dedicated management network port and can support protocols such as Intelligent Platform Management Interface (IPMI) and Redfish. Management controller 150 can provide telemetry and crash data for troubleshooting and proactive maintenance. Management controller 150 can be used to automate the initial setup and firmware updates for servers. Management controller 150 can connect to the server's hardware and provide an interface, via a network port, for management software to interact with. An example management controller 150 can include Baseboard Management Controller (BMC) from Intel®, a specialized microcontroller on server motherboards that allows for remote monitoring and management of the hardware.

Various examples permit a platform error handling mode which can increase uptime and manage SLAs and potentially avoid race conditions between OS 104 and management controller 150 to access error logs. Additionally various examples can avoid security threats that are present in SMM.

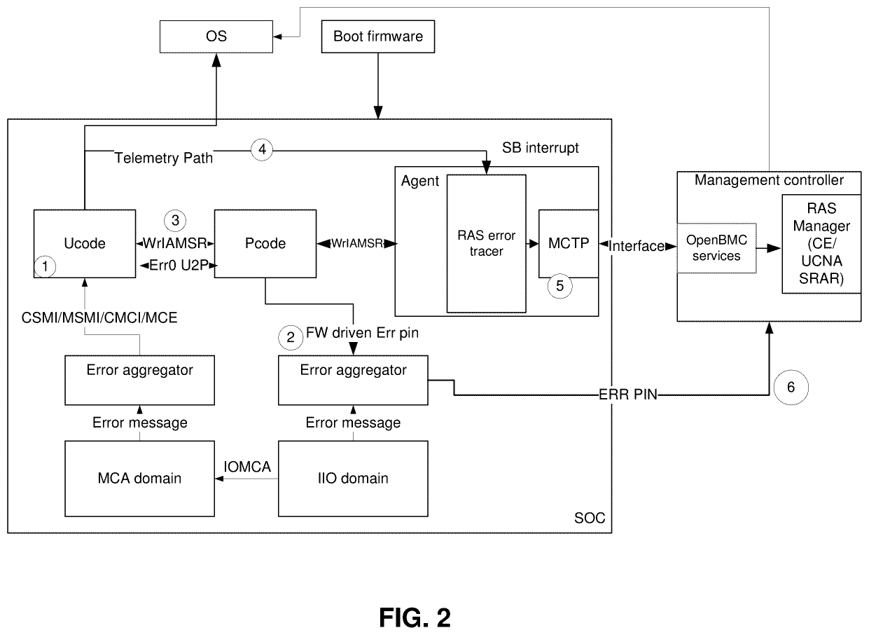

FIG. 2 depicts an example operation of a system when noSMM mode is active. At (1), based on receipt of interrupt signaling (e.g., CSMI), without entering SMM, a core can execute ucode to perform operations that permit error reporting to a management controller. Some errors are hidden from the OS so that the management controller does not race the OS to access and clear errors from registers. For example, such errors may have already been corrected and OS need not terminate or manage processes. At (2), in case of connected error (CE) or uncorrected no action required (UCNA) errors, ucode can cause error aggregator to cause assertion of a pin (e.g., err0) and management controller can respond to the assertion by reading error data from registers (e.g., MCA and error registers). For example, ucode can communicate with error aggregator using ucode to Primecode mailbox (U2P). An error aggregator or escalation can serve as a system configuration controller and can access error data (e.g., CSMI, MCE transmitted over an SMI (MSMI), CMCI, or MCE) from error registers. Management controller can read error data by causing the core to execute a readmsr command. Integrated I/O (IIO) can include inbound and outbound traffic controller and can route error data from registers to error aggregator. At (3), the error data can be cleared to rearm error logging after the management controller reads error information. Management controller can read error data by causing the core to execute a WrIAMSR command. For example, the ucode can clear the register of CE error data by execution of WrIAMSR command.

Some error data is to be accessed by OS and such error data can be copied to a management agent for access by management controller. The error data can be a type where the OS is to perform a corrective action such as terminate process, adjust a physical memory allocated to a memory address because of excessive corrected errors for a memory address, or others. At (4), ucode can cause copying of such error data to Reliability, Availability, and Serviceability (RAS) error tracer buffer of out-of-band management (OOBM) firmware (Ocode). At (5), the management agent can send the error data to management controller. For example, the management agent can utilize a streaming protocol (e.g., Management Component Transport Protocol (MCTP)) to stream error data to management controller.

At (6), management controller can perform error handling of the collected error data. Management controller can observe errors and perform corrective actions such as sparing or soft post package repair to adjust a memory device utilized, adjust a device or processor utilized that is associated with the error, or other actions. In cases where the OS did not access the error data, management controller can send the error data to OS so that OS can access the error data in order to perform corrective actions.

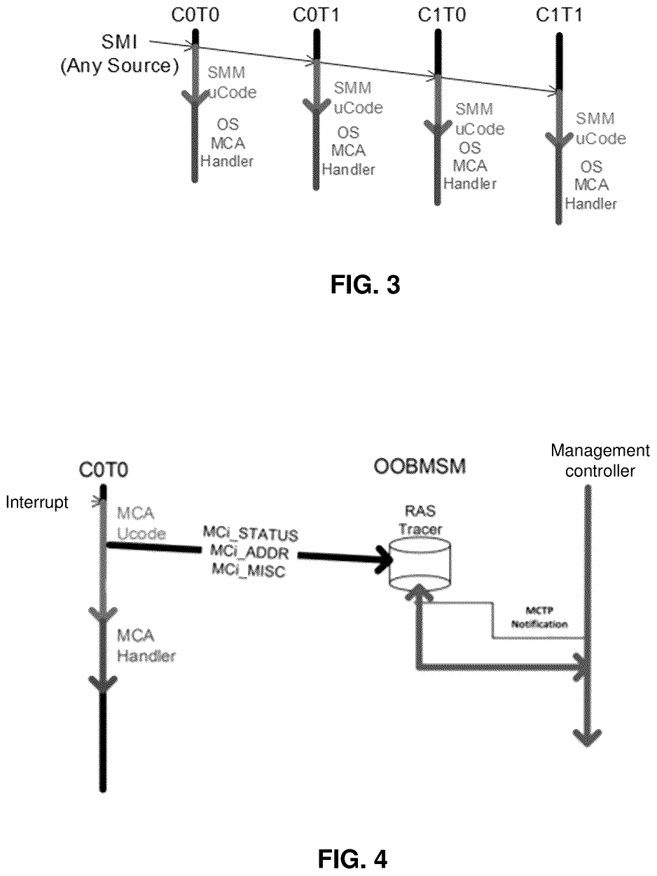

FIG. 3 depicts an example operation in response to an SMI. Cores C0 and C1 can execute respective threads T0 and T1 so that C0T0, C0T1, C1T0, and C1T1 represent respective core C0 executing threads T0 and T1 and core C1 executing threads T0 and T1. Based on receipt of an SMI, uCode on core 0 thread 0 broadcasts the SMI to core 0 thread 1 and core 1, threads 0 and 1. In this example, the noSMM mode is off and threads 0 and 1 of cores 0 and 1 enter SMM mode and OS MCA handlers access errors indicated by the SMI. In another example, the noSMM mode is on, but the SMI is unexpected, and threads 0 and 1 of cores 0 and 1 enter SMM mode and OS MCA handlers access errors indicated by the SMI.

FIG. 4 depicts an example operation. In this example, the noSMM mode is on so if Core 0 executes thread 0 and receives an SMI, SMM is not entered. The SMI refers to an error that is to be accessed by the OS and also copied to the management agent to be made available to the management controller. In some cases, the OS can invoke an MCA handler to handle the errors.

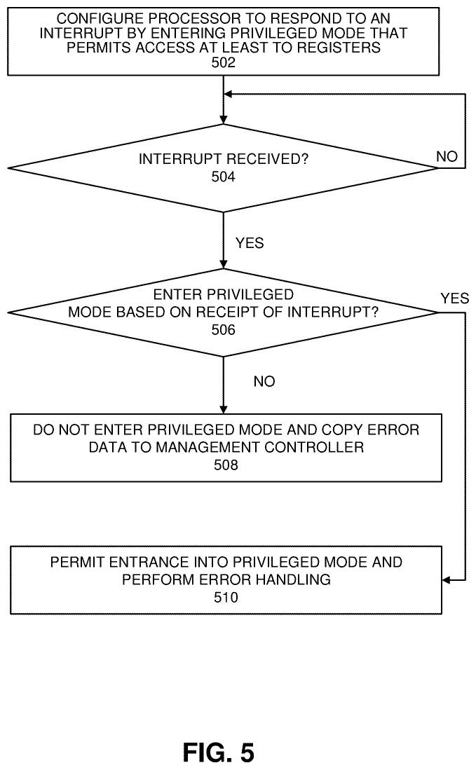

FIG. 5 depicts an example process. The process can be performed by a processor. At 502, a register can be configured to indicate not to enter privileged mode based on receipt of an interrupt or to enter the privileged mode based on receipt of an interrupt. For example, privileged mode can permit access at least to registers to a requester. In some examples, privileged mode includes SMM. In some examples, an interrupt can include a CSMI or SMI. At 504, a determination can be made as to whether an interrupt was received. At 506, based on receipt of an interrupt, a determination can be made as to whether to enter privileged mode. Privileged mode can include SMM, EL3, or a mode that permits firmware or software full access to physical memory and hardware resources. At 508, based on the configuration not permitting entrance to privileged mode, privileged mode is not entered and error data can be copied to a management controller. For example, SMM is not entered and management controller can request to read error data from a register. Management controller can access error data by issuing a command to a core to execute a register read to read the error data from the register and provide the error data to the management controller. Management controller can clear error data in the register by issuing a command to a core to execute a register write. At 510, based on permitting entrance to privileged mode, error handling can be performed. For example, an operating system can access an error identified by the CSMI or SMI and perform corrective actions such as terminating a process or adjusting a physical memory allocated to a memory address.

FIG. 6 depicts a system. System 600 includes processor 610, which can be configured to not enter SMM based on receipt of an interrupt and permit management controller 690 to access error logs via registers or via memory, as described herein. Processor 610 can provide processing, operation management, and execution of instructions for system 600. Processor 610 can include any type of microprocessor, core, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

Management controller 690 can perform management and monitoring capabilities for system administrators to manage and monitor operation at least of system 600 and devices connected thereto, such as, network interface device 650 and storage device 684, using channels, including in-band channels and out-of-band channels. Out-of-band channels can include packet flows or transmission media that communicate metadata and telemetry. In some examples, management controller 690 can be implemented as one or more of: Board Management Controller (BMC), Intel® Management or Manageability Engine (ME), or other devices.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. For example, accelerators 642 can include a load balancer accelerator or circuitry. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600) including cache or registers. In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus comprising: an interface and a core coupled to the interface, wherein based on a configuration, the core is to respond to an interrupt indicating an error by outputting error data to a management controller while permitting thread execution on the core.

Example 2 includes one or more previous or later examples, wherein: based on the configuration, the core is to invoke the management controller to handle errors and not enter System Management Mode (SMM).

Example 3 includes one or more previous or later examples, wherein the management controller is to read the error data from a register and wherein the management controller comprises a microcontroller that is to perform monitoring and management of devices of a server motherboard.

Example 4 includes one or more previous or later examples, wherein: based on the configuration, the core is to respond to the interrupt by suppression of a mode of full access to registers and cause the management controller to issue a read command to the core to cause the core to read the error data from registers and output the error data to the management controller.

Example 5 includes one or more previous or later examples, wherein: based on the configuration, the core is to respond to Corrected Machine Check Interrupt (CMCI) delivered as an System Management Interrupt (SMI) by execution of microcode to invoke the management controller to handle errors but not enter System Management Mode (SMM) and convert the CSMI to a no operation.

Example 6 includes one or more previous or later examples, wherein: based on the configuration, the core is to respond to an error not identified in the configuration by logging a Machine Check Architecture (MCA) error and cause platform reset or shutdown.

Example 7 includes one or more previous or later examples, wherein: based on the configuration, the core is to response to the interrupt by copying the error data to a buffer for access by the management controller and also permit an operating system (OS) to perform error handling in response to the interrupt.

Example 8 includes one or more previous or later examples, and includes at least one non-transitory computer-readable medium comprising instructions stored thereon, that when executed by one or more processors, cause the one or more processors to: based on a configuration: in response to receipt of an interrupt indicating an error, suppress a mode of operation that stalls thread execution to process the interrupt and cause a management controller to request error data associated with the interrupt and handle the interrupt.

Example 9 includes one or more previous or later examples, wherein: the interrupt comprises a Corrected Machine Check Interrupt (CMCI) delivered as an System Management Interrupt (SMI) and the mode of operation comprises System Management Mode (SMM) or Exception Level 3 (EL3) mode.

Example 10 includes one or more previous or later examples, wherein the management controller is to read the error data from a register and wherein the management controller comprises a microcontroller that is to perform monitoring and management of devices of a server motherboard.

Example 11 includes one or more previous or later examples, comprising instructions stored thereon, that when executed by one or more processors, cause the one or more processors to: based on the configuration, translate the interrupt into a no operation and cause the management controller to issue a read command to cause a core of the one or more processors to read the error data from registers and output the error data to the management controller.

Example 12 includes one or more previous or later examples, comprising instructions stored thereon, that when executed by one or more processors, cause the one or more processors to: respond to an error not identified in the configuration by logging a Machine Check Architecture (MCA) error and cause platform reset or shutdown.

Example 13 includes one or more previous or later examples, comprising instructions stored thereon, that when executed by one or more processors, cause the one or more processors to: based on the configuration, a core of the one or more processors is to respond to the interrupt by copying the error data to a buffer for access by the management controller and also permit an operating system (OS) to perform error handling in response to the interrupt.

Example 14 includes one or more previous or later examples, comprising instructions stored thereon, that when executed by one or more processors, cause the one or more processors to: based on a second configuration, a core of the one or more processors is to respond to the interrupt by permitting an operating system (OS) to perform error handling in response to the interrupt.

Example 15 includes one or more previous or later examples, and includes a method that includes: based on a first configuration: in response to receipt of an interrupt indicating an error, suppress System Management Mode (SMM) and cause a management controller to request error data associated with the interrupt and handle the interrupt and based on a second configuration: in response to receipt of a second interrupt indicating a second error, permitting entrance into SMM and permitting an operating system (OS) to handle the second error.

Example 16 includes one or more previous or later examples, wherein: the interrupt comprises a Corrected Machine Check Interrupt (CMCI) delivered as an SMI (CSMI) and the second interrupt comprises a CSMI interrupt.

Example 17 includes one or more previous or later examples, comprising: reading, by the management controller, the error data from a register, wherein the management controller comprises a microcontroller that is to perform monitoring and management of devices of a server motherboard.

Example 18 includes one or more previous or later examples, comprising: responding to an error not identified in the configuration by logging a Machine Check Architecture (MCA) error and cause platform reset or shutdown.

Example 19 includes one or more previous or later examples, comprising: based on the configuration, responding to the interrupt by copying the error data to a buffer for access by the management controller and also permitting an operating system (OS) to perform error handling in response to the interrupt.

Example 20 includes one or more previous examples, comprising: handling the error, by the OS, by performing one or more of: terminating a process or adjusting a physical memory allocated to a memory address.

1. An apparatus comprising:
an interface and
a core coupled to the interface, wherein based on a configuration, the core is to respond to an interrupt indicating an error by outputting error data to a management controller while permitting thread execution on the core.

2. The apparatus of claim 1, wherein:
based on the configuration, the core is to invoke the management controller to handle errors and not enter System Management Mode (SMM).

3. The apparatus of claim 1, wherein the management controller is to read the error data from a register and wherein the management controller comprises a microcontroller that is to perform monitoring and management of devices of a server motherboard.

4. The apparatus of claim 1, wherein: based on the configuration, the core is to respond to the interrupt by suppression of a mode of full access to registers and cause the management controller to issue a read command to the core to cause the core to read the error data from registers and output the error data to the management controller.

5. The apparatus of claim 1, wherein:
based on the configuration, the core is to respond to Corrected Machine Check Interrupt (CMCI) delivered as an System Management Interrupt (SMI) by execution of microcode to invoke the management controller to handle errors but not enter System Management Mode (SMM) and convert the CSMI to a no operation.

6. The apparatus of claim 1, wherein:
based on the configuration, the core is to respond to an error not identified in the configuration by logging a Machine Check Architecture (MCA) error and cause platform reset or shutdown.

7. The apparatus of claim 1, wherein:
based on the configuration, the core is to response to the interrupt by copying the error data to a buffer for access by the management controller and also permit an operating system (OS) to perform error handling in response to the interrupt.

8. At least one non-transitory computer-readable medium comprising instructions stored thereon, that when executed by one or more processors, cause the one or more processors to:
based on a configuration:
in response to receipt of an interrupt indicating an error, suppress a mode of operation that stalls thread execution to process the interrupt and cause a management controller to request error data associated with the interrupt and handle the interrupt.

9. The non-transitory computer-readable medium of claim 8, wherein:
the interrupt comprises a Corrected Machine Check Interrupt (CMCI) delivered as an System Management Interrupt (SMI) and
the mode of operation comprises System Management Mode (SMM) or Exception Level 3 (EL3) mode.

10. The non-transitory computer-readable medium of claim 8, wherein the management controller is to read the error data from a register and wherein the management controller comprises a microcontroller that is to perform monitoring and management of devices of a server motherboard.

11. The non-transitory computer-readable medium of claim 8, comprising instructions stored thereon, that when executed by one or more processors, cause the one or more processors to:
based on the configuration, translate the interrupt into a no operation and cause the management controller to issue a read command to cause a core of the one or more processors to read the error data from registers and output the error data to the management controller.

12. The non-transitory computer-readable medium of claim 8, comprising instructions stored thereon, that when executed by one or more processors, cause the one or more processors to:
respond to an error not identified in the configuration by logging a Machine Check Architecture (MCA) error and cause platform reset or shutdown.

13. The non-transitory computer-readable medium of claim 8, comprising instructions stored thereon, that when executed by one or more processors, cause the one or more processors to:
based on the configuration, a core of the one or more processors is to respond to the interrupt by copying the error data to a buffer for access by the management controller and also permit an operating system (OS) to perform error handling in response to the interrupt.

14. The non-transitory computer-readable medium of claim 8, comprising instructions stored thereon, that when executed by one or more processors, cause the one or more processors to:
based on a second configuration, a core of the one or more processors is to respond to the interrupt by permitting an operating system (OS) to perform error handling in response to the interrupt.

15. A method comprising:
based on a first configuration:
in response to receipt of an interrupt indicating an error, suppress System Management Mode (SMM) and cause a management controller to request error data associated with the interrupt and handle the interrupt and
based on a second configuration:
in response to receipt of a second interrupt indicating a second error, permitting entrance into SMM and permitting an operating system (OS) to handle the second error.

16. The method of claim 15, wherein:
the interrupt comprises a Corrected Machine Check Interrupt (CMCI) delivered as an SMI (CSMI) and
the second interrupt comprises a CSMI interrupt.

17. The method of claim 15, comprising:
reading, by the management controller, the error data from a register, wherein the management controller comprises a microcontroller that is to perform monitoring and management of devices of a server motherboard.

18. The method of claim 15, comprising:
responding to an error not identified in the configuration by logging a Machine Check Architecture (MCA) error and cause platform reset or shutdown.

19. The method of claim 15, comprising:
based on the configuration, responding to the interrupt by copying the error data to a buffer for access by the management controller and also permitting an operating system (OS) to perform error handling in response to the interrupt.

20. The method of claim 15, comprising:
handling the error, by the OS, by performing one or more of: terminating a process or adjusting a physical memory allocated to a memory address.
